(19) United States
(12) Patent Application Publication
(10) Pub. No.: US 2015/0081256 A1
(43) Pub. Date: Mar. 19, 2015

(54) Method of Designing Cable Dome Structure Based on Bearing Whole Process Analysis

(71) Applicant: China Aviation Planning and Construction Development Co., Ltd., Beijing (CN)

(72) Inventors: Jiaqi Ge, Beijing (CN); Guojun Zhang, Beijing (CN); Shu Wang, Beijing (CN); Botao Ma, Beijing (CN); Xingang Liu, Beijing (CN)

(21) Appl. No.: 14/500,185

(22) Filed: Sep. 29, 2014

Related U.S. Application Data
(63) Continuation of application No. PCT/CN13/73731, filed on Apr. 3, 2013.

(30) Foreign Application Priority Data
Apr. 4, 2012 (CN) 201210095739.6

(51) Int. Cl. G06F 17/50

(52) U.S. Cl. CPC G06F 17/5009
USPC 703/1

(57) ABSTRACT

A method of designing a cable dome structure based on a cable dome bearing whole process analysis. The cable dome bearing whole process has three stages comprising a ridge cable relaxation, a ring cable yield and a structure failure.

### CROSS-REFERENCE TO RELATED APPLICATIONS

This application is a continuation application of Patent Cooperation Treaty Application No. CN2013/073731, filed on Apr. 3, 2013, which claims priority to and the benefit of the filing of China Patent Application Ser. No. 201210095739.6, filed on Apr. 4, 2012, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### FIELD OF THE INVENTION

The present invention relates to a field of pre-stress steel structure, more particularly, relates to a method of designing a cable dome structure.

### BACKGROUND OF THE INVENTION

A cable dome structure relates to new material, new technology and new process, and has a reasonable stress characteristics and high structure efficiency. Thereby, the cable dome structure is one of modern architecture systems that can epitomize advanced material, design and construction technology level in modern architecture.

As shown in FIG. 1, the cable dome mainly is composed of four parts comprising a continuous tension cable net, a compression support bar 5, a middle tension ring 6, and a peripheral compression ring truss (not shown), wherein the continuous tension cable net is composed of a ridge cable 2, a slope cable 4 and a ring cable 3. In FIG. 1, a control point is indicated by 1. The cable dome structure may further comprise a cable membrane sub-structure (not shown), the cable membrane sub-structure may comprise a membrane tensioned on the ridge cable and a valley cable provided between radial ridge cables. The prestressing force is applied so that all cables in the continuous tension cable net are tensioned and can bear the designed load. Thereby, the continuous tension cable net is the main force bearing member of the cable dome structure, and embodies an advanced structural mechanics concept of a continuous tension ocean.

In the prior art, the design of the cable dome structure is only limited to an elastic design stage mainly comprising member elasticity bearing capacity design and small system deformation capacity design. During designing in the prior, however, it is still blind and random to determine design indexes of the cable dome structure.

### SUMMARY OF THE INVENTION

According to an object of the present invention, there is provided a method of determining design indexes of a cable dome structure based on a bearing whole process. The bearing whole process means a whole process of gradually loading the structure from an initial state, where the structure bears only self weight and an initial prestressing force of cable, until the structure is damaged.

In an exemplary embodiment, based on load-mechanical response characteristics of three stages, ridge cable relaxation-ring cable yield-structure failure, in the cable dome bearing whole process, obtaining a system elastic bearing capacity coefficient, a system stable bearing capacity coefficient and a system deformation capacity coefficient. In this way, it provides scientific basis and method for determining the design indexes of the cable dome structure. Please be noted that the stage of ridge cable relaxation means a condition where a tension stressing force on the ridge cable is equal to 0 Mpa; the stage of ring cable yield means a condition where a stressing force on the ring cable without obvious yield point, for example, a high strength steel strand, goes beyond 0.8 times of the yield stressing force of it (please be noted that even if there is no obvious yield point, a nominal yield point also can be calculated), as for the ring cable with obvious yield point, it corresponds to an inflection point, for example, a point P_{y}*=6.5 in FIG. 7.

The present invention provides a method of designing a cable dome structure, wherein the cable dome comprising a ridge cable and a ring cable, and the method comprising steps of: gradually loading the cable dome in a computer simulation or a model test, so that the cable dome is subjected to a bearing whole process having three stages comprising a ridge cable relaxation, a ring cable yield and a structure failure.

According to an aspect of the present invention, the method comprising steps of:

(1) by taking the ridge cable relaxation as a determination condition, calculating a system elastic bearing capacity coefficient K;

(2) by taking the ring cable yield as a determination condition, calculating a system yield load coefficient P_{y}* and a system yield deformation coefficient D_{y}*;

(3) by taking the structure failure as a determination condition, calculating a cable dome system failure load coefficient 1³,, and a system ultimate deformation coefficient Dᵤ;

(4) obtaining a system strength safety coefficient λ_{P} , a system deformation ductility safety coefficient λ_{D}, a system deformation coefficient allowable value [D], and a load coefficient P_{[D]} corresponding to the system deformation coefficient allowable value [D];

(5) calculating a system stable bearing capacity coefficient P^{λ} of the cable dome based on an expression: P_{λ}=min {P_{y}*, Pᵤ/λ_{P}, P_{[D]}}, and calculating a system deformation capacity coefficient D_{λ} of the cable dome based on an expression:

D_{λ}=min{D_{y}*,Dᵤ/λ_{D},[D]}.

According to another aspect of the present invention, the method comprising steps of:

(1) by taking the ridge cable relaxation as a determination condition, calculating a system elastic bearing capacity coefficient K;

(3) by taking the structure failure as a determination condition, calculating a cable dome system failure load coefficient Pᵤ and a system ultimate deformation coefficient Dᵤ;

(4) obtaining a system strength safety coefficient λ_{P}, a system deformation ductility safety coefficient λ_{D} , a system deformation coefficient allowable value [D], and a load coefficient P_{[D]} corresponding to the system deformation coefficient allowable value [D];

(5) calculating a system stable bearing capacity coefficient P_{λ} of the cable dome based on an expression: P_{λ}=min{Pᵤ/λ_{P},P_{[D]}}; and calculating a system deformation capacity coefficient D_{λ} of the cable dome based on an expression: D_{λ}=min{Dᵤ/λ_{D}, [D]}.

Optionally, the above method may further comprise steps of:

(6) conducting a material mechanics test on the cable in laboratory to obtain an elastic modulus, a yield strength, a ultimate strength, and a linear expansivity of material, conducting a mechanics test on a joint of the cable and a cable clamp in laboratory to obtain a friction coefficient and a restraint stiffness of the joint;

(7) based on a computer simulation or a model test, obtaining a relation between a system load coefficient and a cable force in a bearing whole process and a relation between the system load coefficient and a system deformation capacity in the bearing whole process,

wherein:

in the step (1), based on a relation between the system load coefficient and a ridge cable stressing force, calculating the system elastic bearing capacity coefficient K;

in the step (2), based on a relation between the system load coefficient and a ring cable stressing force, calculating the system yield load coefficient P_{y}* and the system yield deformation coefficient D_{y}*;

in the step (3), based on a relation between the system load coefficient and the system deformation capacity, calculating the cable dome system failure load coefficient Pᵤ and the system ultimate deformation coefficient Dᵤ.

In an exemplary embodiment of the present invention, the cable dome structure bearing whole process analysis is achieved by a computer simulation analysis, and wherein based on a test result obtained in the step (6), setting the material model of the cable dome structure as a nonlinear model; based on the test result obtained in the step (6), considering an effect of a pre-stress loss of the cable and the cable clamp joint restraint stiffness in a calculation model, and considering the cable dome structure system geometrical nonlinearity in calculation; conducting the analysis in a soft ware of ANSYS, and adopting a nonlinear iteration strategy for the calculation. A calculation process matrix equation of the nonlinear iteration strategy is expressed as follows:

[K_{n,i}^{T}]{Δuᵢ}={Fₙ^{a}}−{F_{n,i}}

wherein

[K_{n,i}^{T}] is a tangential stiffness matrix of i^{th} iteration step in n^{th} load step;

{Fₙ^{a}} is a load vector of n^{th} load step;

{F_{n,i}} is a restoring force vector of ith iteration step in nth load step;

{Δui} is a displacement increment of ith iteration step.

Alternatively, in the above method, during designing the cable dome structure, simultaneously controlling the system elastic bearing capacity coefficient K, the system stable bearing capacity coefficient P_{λ} and the system deformation capacity coefficient D^{λ}.

Alternatively, in the step (1) of the above method, gradually loading the cable dome structure until K times of design load is applied on the cable dome.

With the technology solution of the present invention, relations among parameters, such as a system stable bearing capacity, a system deformation capacity and cable stressing forces (for example, stressing forces in the ridge cable, the ring cable and the slope cable), in three stages comprising the ridge cable relaxation, the ring cable yield and the structure failure have been analyzed during designing the cable dome structure, that is, load-mechanical response characteristics of the three stages, ridge cable relaxation-ring cable yield-structure failure, in the cable dome bearing whole process is analyzed. In this way, it considers not only a basic safety design requirements on the cable dome structure, but also considers a safety margin beyond safety design standard. Furthermore, there is also provided a method of determining three control index coefficients for the cable dome structure system safety design based on the bearing whole process.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative structure view of a cable dome structure in the prior art;

FIG. 2 is a flow chart of a method of determining a cable dome structure design indexes based on a bearing whole process according to an exemplary embodiment of the present invention;

FIG. 3 is an illustrative view of a load-mechanical response characteristics nonlinear iteration process of a structure bearing whole process according to an exemplary embodiment of the present invention, wherein, horizontal ordinate U indicates a displacement, vertical ordinate F indicates a restoring force, underhorn reference i indicates the i^{th} step in the iteration process, F^{a} is a target load;

FIG. 4 is a curve graph indicating a relation between a system load coefficient P and a ridge cable stressing force a according to an exemplary embodiment of the present invention, wherein, horizontal ordinate a indicates a ridge cable stressing force, vertical ordinate system load coefficient P is a ratio of a cable dome system load to an external load, that is, a load multiple applied on the structure during the bearing whole process analysis;

FIG. 5 is a curve graph indicating a relation between a system load coefficient P and a deformation coefficient D according to an exemplary embodiment of the present invention, wherein, horizontal ordinate deformation coefficient D is a ratio of a cable dome system vertical deformation to a span, the curve of FIG. 5 is called as P-D curve, Pᵤ, Dᵤ indicate a system failure load coefficient and a system ultimate deformation coefficient, respectively, P_{y}*, D_{y}* indicate a cable dome system yield load coefficient and a system yield deformation coefficient, respectively, P_{D1/40}, D_{1/40} indicate a system load coefficient and a system deformation coefficient as the deformation is equal to 1/40 of structure span, respectively;

FIG. 6 is a curve graph indicating a relation between a system load coefficient and a ridge cable stressing force according to an exemplary embodiment of the present invention, wherein, a curve a indicates an inner ridge cable stressing force calculated based on double nonlinear analysis, a curve b indicates a middle ridge cable stressing force calculated based on double nonlinear analysis, a curve c indicates an outer ridge cable stressing force calculated based on double nonlinear analysis;

FIG. 7 is a curve graph indicating a relation between a system load coefficient and a ring cable stressing force according to an exemplary embodiment of the present invention, wherein, a curve a indicates a middle ring cable stressing force calculated based on double nonlinear analysis, a curve b indicates an outer ring cable stressing force calculated based on double nonlinear analysis; and

FIG. 8 is a curve graph indicating a relation between a system load coefficient and a displacement according to an exemplary embodiment of the present invention, wherein, a curve a indicates a displacement in a direction of Ux of a control point calculated based on double nonlinear analysis, a curve b indicates a displacement in a direction of Uy of a control point calculated based on double nonlinear analysis, a curve c indicates a displacement in a direction of Uz of a control point calculated based on double nonlinear analysis.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

The present invention provides a method of designing a cable dome structure. The cable dome comprises a ridge cable and a ring cable. The method comprises step of: gradually loading the cable dome in a computer simulation or a model test, so that the cable dome is subjected to a bearing whole process having three stages comprising a ridge cable relaxation, a ring cable yield and a structure failure.

In the present invention, different from the design in the prior art, relations among parameters, such as a system stable bearing capacity, a system deformation capacity and cable stressing forces (for example, stressing forces in the ridge cable, the ring cable and the slope cable), in three stages comprising the ridge cable relaxation, the ring cable yield and the structure failure have been analyzed during designing the cable dome structure, that is, load-mechanical response characteristics of the three stages, ridge cable relaxation-ring cable yield-structure failure, in the cable dome bearing whole process is analyzed. In this way, it considers not only a basic safety design requirements on the cable dome structure, but also considers a safety margin beyond safety design standard.

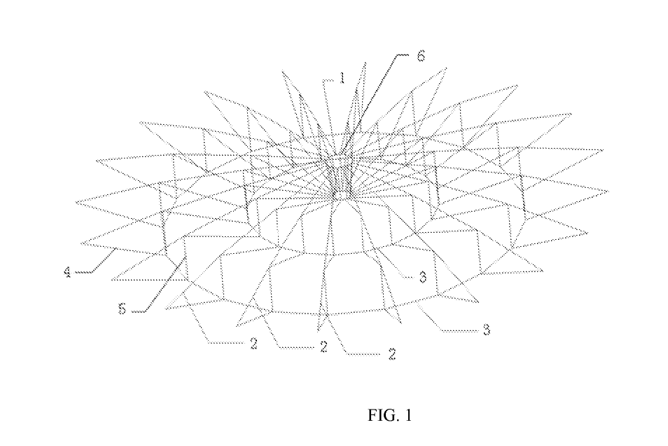

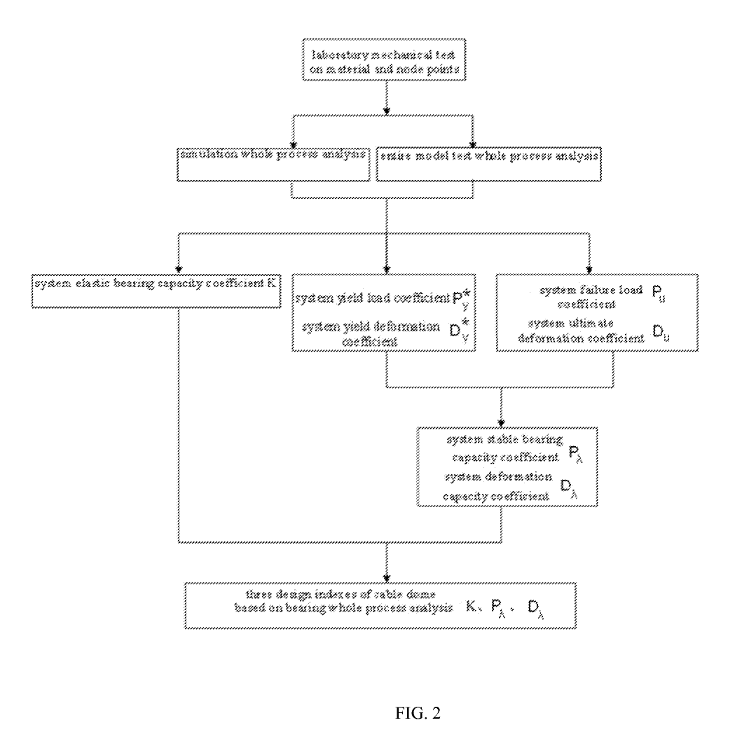

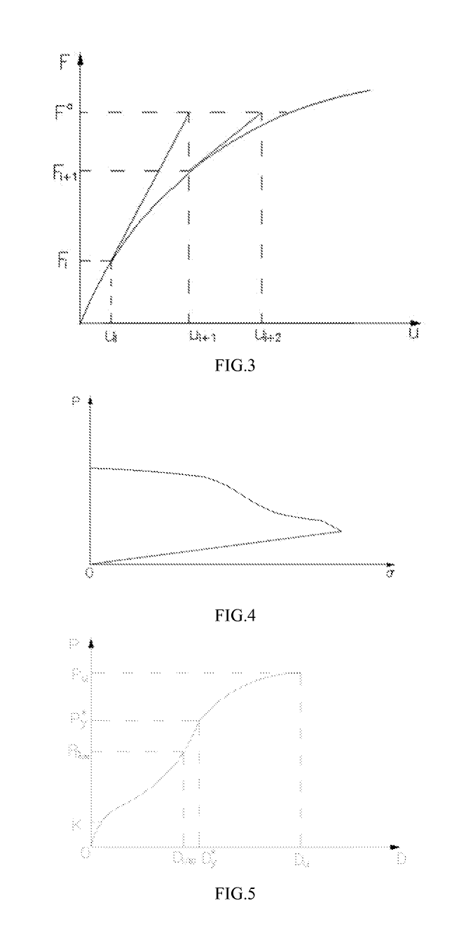

Hereafter, it will describe the method of designing the cable dome structure based on the bearing whole process with reference to FIGS. 1-8. The method comprises steps of:

(1) by taking the ridge cable 2 relaxation as a determination condition, calculating a system elastic bearing capacity coefficient K. FIG. 4 is a curve graph indicating a relation between a system load coefficient P and a ridge cable stressing force a according to an exemplary embodiment of the present invention, wherein, horizontal ordinate σ indicates a ridge cable stressing force, vertical ordinate system load coefficient P is a ratio of a cable dome system load to an external load, that is, a load multiply applied on the structure during the bearing whole process analysis. A curve inflection point can be seen, and the cable dome is in an approximate elastic bearing zone before the curve inflection point is occurred. The mechanical properties of the cable dome have significant changes once the curve inflection point is occurred, and thus the internal force is redistributed. Thereby, the inflection point is defined as the cable dome system elastic bearing capacity coefficient K and referred as a design index.

(2) by taking the ring cable 3 yield as a determination condition, calculating a system yield load coefficient P_{y}* and a system yield deformation coefficient D_{y}*. For example, FIG. 5 is a curve graph indicating a relation between a system load coefficient P and a deformation coefficient D according to an exemplary embodiment of the present invention, wherein, horizontal ordinate deformation coefficient D is a ratio of a cable dome system vertical deformation to a span, the curve of FIG. 5 is called as P-D curve, Pᵤ, Dᵤ indicate a system failure load coefficient and a system ultimate deformation coefficient, respectively, P_{y}*, D_{y}* indicate a cable dome system yield load coefficient and a system yield deformation coefficient, respectively, P_{D1/40}, D_{1/40} indicate a system load coefficient and a system deformation coefficient as the deformation is equal to 1/40 of structure span, respectively. It can be seen from natural characteristics of the cable dome, the ring cable 3 has a nominal yield point, that is, the inflection point of FIG. 5, thereby, the system yield load coefficient P_{y}* and the system yield deformation coefficient D_{y}* are defined.

(3) by taking the structure failure as a determination condition, calculating a cable dome system failure load coefficient Pᵤ and a system ultimate deformation coefficient Dᵤ. For example, based on the curve of FIG. 5, the cable dome system failure load coefficient Pᵤ and the system ultimate deformation coefficient Dᵤ can be obtained.

(4) obtaining a system strength safety coefficient λ_{P}, a system deformation ductility safety coefficient λ_{D}, a system deformation coefficient allowable value [D], and a load coefficient P_{[D]} corresponding to the system deformation coefficient allowable value [D];

(5) calculating a system stable bearing capacity coefficient P^{λ} of the cable dome based on an expression: P_{λ}=min {P_{y}*,Pᵤ/λ_{P},P_{[D]}}, and calculating a system deformation capacity coefficient D_{λ} of the cable dome based on an expression:

D_{λ}=min{D_{y}*,Dᵤ/λ_{D},[D]}.

Optionally, in a case where the ring cable does not have a yield point (or the yield point cannot be obtained), the above step (2) can be omitted. Correspondingly, in the step (5), the system stable bearing capacity coefficient P^{λ} of the cable dome is calculated based on an expression: P_{λ}=min{Pᵤ/λ_{P},P_{[D]}}, and the system deformation capacity coefficient D_{λ} of the cable dome is calculated based on an expression: D_{λ}=min{Dᵤ/λ_{D}, [D]}.

The system stable bearing capacity coefficient P_{λ}, the system deformation capacity coefficient D_{λ} and the system elastic bearing capacity coefficient K may be used as three indexes of designing the cable dome structure.

Optionally, the above method may further comprise steps of:

(6) conducting a material mechanics test on the cable in laboratory to obtain an elastic modulus (Eₛ), a yield strength (f_{y}), a ultimate strength (fᵤ), and a linear expansivity of material (a), conducting a mechanics test on a joint of the cable and a cable clamp in laboratory to obtain a friction coefficient (u) and a restraint stiffness (k) of the joint;

(7) based on a computer simulation or a model test, obtaining a relation between a system load coefficient and a cable force in a bearing whole process and a relation between the system load coefficient and a system deformation capacity,

wherein:

in the step (1), based on a relation between the system load coefficient and a ridge cable stressing force, calculating the system elastic bearing capacity coefficient K;

in the step (3), based on a relation between the system load coefficient and the system deformation capacity, calculating the cable dome system failure load coefficient Pᵤ and the system ultimate deformation coefficient Dᵤ.

In an exemplary embodiment of the present invention, the cable dome structure loading whole process analysis is achieved by a computer simulation analysis, and wherein based on a test result obtained in the step (6), setting the material model of the cable dome structure as a nonlinear model; based on the test result obtained in the step (6), considering an effect of a pre-stress loss of the cable and the cable clamp joint restraint stiffness in a calculation model, and considering the cable dome structure system geometrical nonlinearity in calculation; conducting the analysis in a soft ware of ANSYS, and adopting a nonlinear iteration strategy for the calculation. A calculation process matrix equation of the nonlinear iteration strategy is expressed as follows:

[K_{n,i}^{T}]{Δuᵢ}={Fₙ^{a}}−{F_{n,i}}

wherein

[K_{n,i}^{T}] is a tangential stiffness matrix of i^{th} iteration step in n^{th} load step;

{Fₙ^{a}} is a load vector of n^{th} load step;

{F_{n,i}} is a restoring force vector of i^{th} iteration step in n^{th} load step;

{Δuᵢ} is a displacement increment of i^{th} iteration step.

Optionally, in the above method, during designing the cable dome structure, simultaneously controlling the system elastic bearing capacity coefficient K, the system stable bearing capacity coefficient P_{λ} and the system deformation capacity coefficient D_{λ}.

Optionally, in the step (1) of the above method, gradually loading the cable dome structure until K times of design load is applied on the cable dome.

Hereafter, it will further describe in detail the method and its application of the present invention by an engineering example.

Engineering example: cable dome structure engineering

FIG. 1 shows a cable dome structure. At periphery of the cable dome, there is provided a truss configuration formed by intersecting large span steel pipes (not shown) which are radially arranged. At the center of the cable dome, there is provided a rib ring type cable dome configuration having a span of 71.2 m and a vector height of 5.5 m, 20 radial ridge cables 2 and 2 ring cables 3.

Step (1):

conducting a material mechanics test on the cable in laboratory to obtain an elastic modulus Eₛ=1.9×10⁵ MPa, a (nominal) yield strength f_{y}=1330 MPa, a ultimate strength fᵤ=1670 MPa, and a linear expansivity α=1.2×10⁻⁵/, conducting a mechanics test on a joint of the cable and a cable clamp in laboratory to obtain a friction coefficient and a restraint stiffness of the joint, and 3% of loss is considered during calculation.

Step (2):

Conducting the cable dome structure bearing whole process analysis, and based on a test result in the laboratory, setting the material model of the cable dome structure as a nonlinear model; considering an effect of a pre-stress loss of the cable and the cable clamp joint restraint stiffness in a calculation model; and conducting the analysis in a soft ware of ANSYS, and adopting a nonlinear iteration strategy for the calculation.

Step (3):

Based on the calculation of the bearing whole process of step (2), FIG. 6 is obtained. That is, applying K times of design load on the cable dome, and taking the ridge cable relaxation as the determination condition, a proper system elastic bearing capacity coefficient K=1.5 is calculated. The ridge cable is divided into an inner ridge cable, a middle ridge cable and an outer ridge cable by a compression support bar. FIG. 6 shows the relation curves of load coefficient-ridge cable stressing force of these ridge cables.

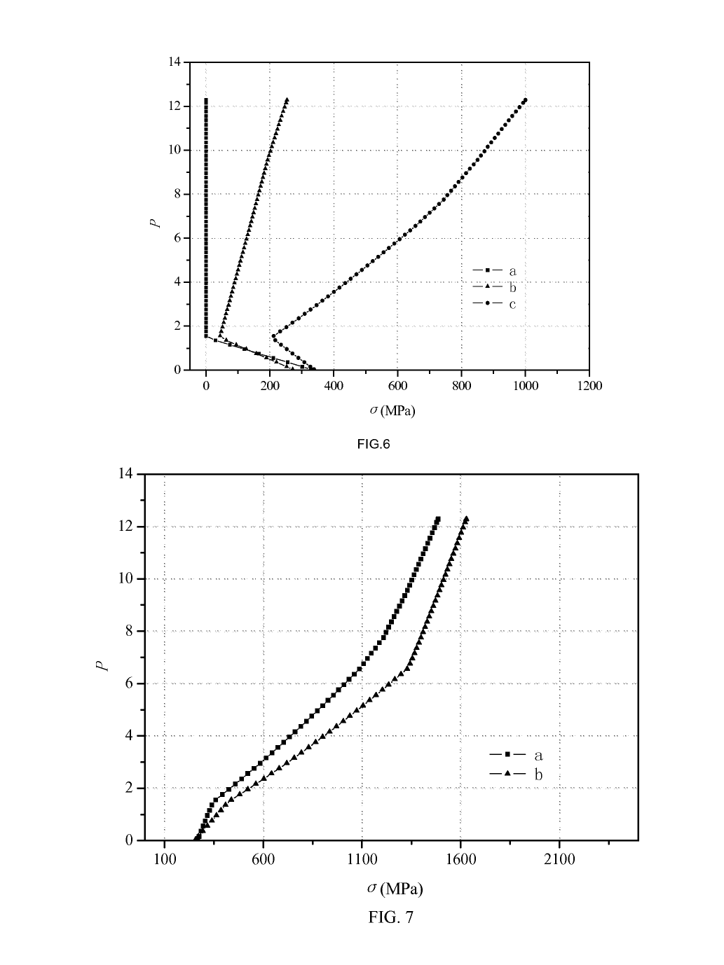

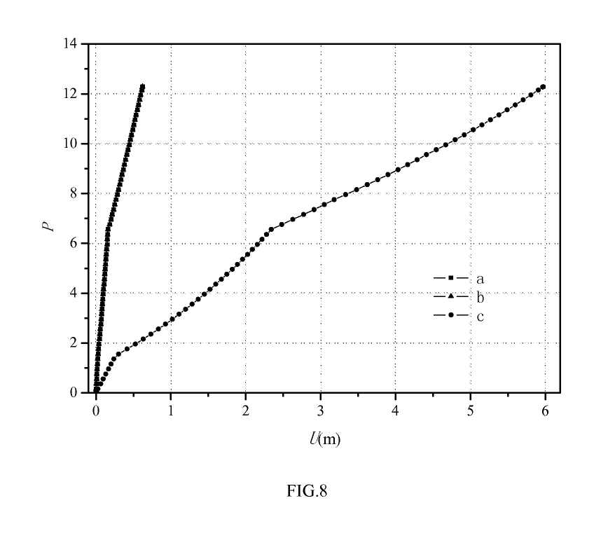

Based on the calculation of the bearing whole process of step (2), FIGS. 7 and 8 are obtained. That is, taking the ring cable yield as the determination condition, the system yield load coefficient P_{y}* and the system yield deformation coefficient D_{y}* of the cable dome are calculated.

Based on the bearing whole process analysis, it may obtain the system yield load coefficient P_{y}*=6.5 and the system yield deformation coefficient D_{y}*=1/42 when the outer ring cable is yielded.

Taking the structure failure as the determination condition, based on the bearing whole process analysis, it may obtain the cable dome system failure load coefficient Pᵤ=12 and the system ultimate deformation coefficient Dᵤ=1/13.

Step (4):

The system strength safety coefficient λ_{P} is set to be larger than or equal to 1.2 and less than or equal to 1.5. In this engineering example, the system strength safety coefficient λ_{P} is equal to 1.5. The system deformation ductility safety coefficient λ^{D} is set to be larger than or equal to 1.2 and less than or equal to 1.8. In this engineering example, the system deformation ductility safety coefficient λ_{D} is equal to 1.8. The system deformation coefficient allowable value [D] is set to be in a range of 1/30˜1/50. In this engineering example, the system deformation coefficient allowable value [D] is equal to 1/40. The load coefficient P_{[D]} corresponding to the system deformation coefficient allowable value [D] is equal to 6.6.

Based on the indexes obtained in the above steps, it can obtain the system stable bearing capacity coefficient P_{λ} and the system deformation capacity coefficient D_{λ}:

P_{λ}=min{6.5, 8.2, 6.6}=6.5

D_{λ}=min{1/42, 1/21.42, 1/40}=1/42

In sum, it can obtain the method of designing the cable dome structure of this engineering example based on the bearing whole process, more particularly, the method of determining the design indexes of the cable dome structure. In this engineering example, the system elastic bearing capacity coefficient K is determined to be equal to 1.5, the system stable bearing capacity coefficient P_{λ} is determined to be equal to 6.5, system deformation capacity coefficient P_{λ} determined to be equal to 1/42.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A method of designing a cable dome structure, wherein the cable dome comprises a ridge cable and a ring cable, and the method comprises the steps of:
gradually loading the cable dome in a computer simulation or a model test, so that the cable dome is subjected to a bearing whole process having three stages comprising a ridge cable relaxation, a ring cable yield and a structure failure.

2. The method according to claim 1, additionally comprising the steps of:
(1) by taking the ridge cable relaxation as a determination condition, calculating a system elastic bearing capacity coefficient K;
(2) by taking the ring cable yield as a determination condition, calculating a system yield load coefficient P_{y}* and a system yield deformation coefficient D_{y}*;
(3) by taking the structure failure as a determination condition, calculating a cable dome system failure load coefficient Pᵤ and a system ultimate deformation coefficient Dᵤ;
(4) obtaining a system strength safety coefficient λ_{P}, a system deformation ductility safety coefficient λ_{D}, a system deformation coefficient allowable value [D], and a load coefficient P_{[D]} corresponding to the system deformation coefficient allowable value [D]; and
(5) calculating a system stable bearing capacity coefficient P_{λ} of the cable dome based on an expression: P_{λ}=min {P_{y}*,Pᵤ/λ_{P},P_{[D]}}, and calculating a system deformation capacity coefficient D_{λ} of the cable dome based on an expression: D_{λ}=min{D_{y}*,Dᵤ/λ_{D},[D]}.

3. The method according to claim 2, further comprising the steps of:
(6) conducting a material mechanics test on the cable in laboratory to obtain an elastic modulus, a yield strength, a ultimate strength, and a linear expansivity of material, conducting a mechanics test on a joint of the cable and a cable clamp in laboratory to obtain a friction coefficient and a restraint stiffness of the joint; and
(7) based on a computer simulation or a model test, obtaining a relation between a system load coefficient and a cable force and a relation between the system load coefficient and a system deformation capacity in the bearing whole process,
wherein:
in the step (1), based on a relation between the system load coefficient and a ridge cable stressing force, calculating the system elastic bearing capacity coefficient K;
in the step (2), based on a relation between the system load coefficient and a ring cable stressing force, calculating the system yield load coefficient P_{y}* and the system yield deformation coefficient D_{y}*; and
in the step (3), based on a relation between the system load coefficient and the system deformation capacity, calculating the cable dome system failure load coefficient Pᵤ and the system ultimate deformation coefficient Dᵤ.

4. The method according to claim 1, additionally comprising the steps of:
(1) by taking the ridge cable relaxation as a determination condition, calculating a system elastic bearing capacity coefficient K;
(2) by taking the structure failure as a determination condition, calculating a cable dome system failure load coefficient Pᵤ and a system ultimate deformation coefficient Dᵤ;
(3) obtaining a system strength safety coefficient λ_{P}, a system deformation ductility safety coefficient λ_{D}, a system deformation coefficient allowable value [D], and a load coefficient P_{[D]} corresponding to the system deformation coefficient allowable value [D]; and
(4) calculating a system stable bearing capacity coefficient P_{λ} of the cable dome based on an expression: P_{λ}=min{Pᵤ/λ_{P},P_{[D]}}, and calculating a system deformation capacity coefficient D_{λ} of the cable dome based on an expression: D_{λ}=min{Dᵤ/λ_{D},[D]}.

5. The method according to claim 4, further comprising the steps of:
(5) conducting a material mechanics test on the cable in laboratory to obtain an elastic modulus, a yield strength, a ultimate strength, and a linear expansivity of material, conducting a mechanics test on a joint of the cable and a cable clamp in laboratory to obtain a friction coefficient and a restraint stiffness of the joint; and
(6) based on a computer simulation or a model test, obtaining a relation between a system stable bearing capacity and a cable force and a relation between the system stable bearing capacity and a system deformation capacity in the bearing whole process,
wherein:
in the step (1), based on a relation between the system load coefficient and a ridge cable stressing force, calculating the system elastic bearing capacity coefficient K; and
in the step (2), based on a relation between the system load coefficient and the system deformation capacity, calculating the cable dome system failure load coefficient Pᵤ and the system ultimate deformation coefficient Dᵤ.

6. The method according to claim 2, wherein
during designing the cable dome structure, simultaneously controlling the system elastic bearing capacity coefficient K, the system stable bearing capacity coefficient P^{λ} and the system deformation capacity coefficient D_{λ}.

7. The method according to claim 3, wherein
during designing the cable dome structure, simultaneously controlling the system elastic bearing capacity coefficient K, the system stable bearing capacity coefficient P_{λ} and the system deformation capacity coefficient D_{λ}.

8. The method according to claim 4, wherein
during designing the cable dome structure, simultaneously controlling the system elastic bearing capacity coefficient K, the system stable bearing capacity coefficient P_{λ} and the system deformation capacity coefficient D_{λ}.

9. The method according to claim 5, wherein
during designing the cable dome structure, simultaneously controlling the system elastic bearing capacity coefficient K, the system stable bearing capacity coefficient P_{λ} and the system deformation capacity coefficient D_{λ}.

10. The method according to claim 3, wherein
the cable dome structure bearing whole process analysis is achieved by a computer simulation analysis, and wherein based on a test result obtained in the step (6), setting the material model of the cable dome structure as a nonlinear model; based on the test result obtained in the step (6), considering an effect of a pre-stress loss of the cable and the cable clamp joint restraint stiffness in a calculation model, and considering the cable dome structure system geometrical nonlinearity in calculation; conducting the analysis in a soft ware of ANSYS, and adopting a nonlinear iteration strategy for the calculation.

11. The method according to claim 5, wherein
the cable dome structure bearing whole process analysis is achieved by a computer simulation analysis, and wherein based on a test result obtained in the step (6), setting the material model of the cable dome structure as a nonlinear model; based on the test result obtained in the step (6), considering an effect of a pre-stress loss of the cable and the cable clamp joint restraint stiffness in a calculation model, and considering the cable dome structure system geometrical nonlinearity in calculation; conducting the analysis in a soft ware of ANSYS, and adopting a nonlinear iteration strategy for the calculation.

12. The method according to claim 10, wherein
a calculation process matrix equation of the nonlinear iteration strategy is expressed as follows:
[K_{n,i}^{T}]{Δuᵢ}={Fₙ^{a}}−{F_{n,i}}
wherein
[K_{n,i}^{T}] is a tangential stiffness matrix of i^{th} iteration step in n^{th} load step;
{Fₙ^{a}} is a load vector of n^{th} load step;
{F_{n,i}} is a restoring force vector of i^{th} iteration step in n^{th} load step;
{Δuᵢ} is a displacement increment of i^{th} iteration step.

13. The method according to claim 11, wherein
a calculation process matrix equation of the nonlinear iteration strategy is expressed as follows:
[K_{n,i}^{T}]{Δuᵢ}={Fₙ^{a}}−{F_{n,i}}
wherein
[K_{n,i}^{T}] is a tangential stiffness matrix of i^{th} iteration step in n^{th} load step;
{Fₙ^{a}} is a load vector of n^{th} load step;
{F_{n,i}} is a restoring force vector of i^{th} iteration step in n^{th} load step;
{Δuᵢ} is a displacement increment of i^{th} iteration step.

14. The method according to claim 2, wherein
in the step (1), gradually loading the cable dome structure until K times of design load is applied on the cable dome.

15. The method according to claim 2, wherein
the system strength safety coefficient λ_{P} is set to be larger than or equal to 1.2 and less than or equal to 1.5.

16. The method according to claim 2, wherein
the system deformation ductility safety coefficient λ_{D} s set to be larger than or equal to 1.2 and less than or equal to 1.8.
